(19) United States
(12) Patent Application Publication
(10) Pub. No.: US 2007/0086659 A1
(43) Pub. Date: Apr. 19, 2007

(54) Method for groupwise point set matching

(76) Inventors: Christophe Chefd'hotel, Princeton, NJ (US); Kinda Anna Saddi, Hamilton, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/518,763

(22) Filed: Sep. 11, 2006

Related U.S. Application Data
(60) Provisional application No. 60/727,673, filed on Oct. 18, 2005.

(51) Int. Cl. G06K 9/62

(52) U.S. Cl. 382/225

(57) ABSTRACT

A method for registering a collection of m input point sets or images {P₁, P₂, . . . , Pₘ}, where m is an integer. The method identifies a set of m rigid (or affine) transformations {T₁, T₂, . . . , Tₘ} aligning such images comprising determining a mean of the input point sets or images {P₁, P₂, . . . , Pₘ} and aligning the images using the determined mean in performing the transformation alignment. The method extends image matching using only a pair of point sets (i.e., from registration of only a pair of images) to a collection of point sets (i.e., registration of more than a pair of images).

### CROSS REFERENCE TO RELATED APPLICATION

This application claims priority from U.S. Provisional application No. 60/727,673 filed Oct. 18, 2005, which is incorporated herein by reference.

### TECHNICAL FIELD

This invention relates generally to image registration and more particularly to image registration using point set matching.

### BACKGROUND

As is known in the art, image registration is the process of identifying a geometric transformation that aligns images into the same coordinate frame. One of the main areas of application for image registration is medical imaging. For example, when an image of an organ of a patient taken at one time is to be matched with the image of the organ of the patient at a later time. The accurate alignment and fusion of 2D and 3D images obtained from various imaging technologies (e.g. MRI, CT, X-Ray, Ultrasound) facilitates the work of clinicians and radiologists. In the context of medical image registration, this collection could represent feature points extracted from a sequence of images of the same patient (over time), or from a population study including images from different patients.

Registration algorithms are often divided into two categories: intensity based and feature based. We focus here on the latter category where significant image features, modeled as curves, surfaces or point sets, are extracted from the images to establish correspondences and estimate geometric transformations.

In this context, the iterative closest point (ICP) algorithm introduced by Besl and McKay on a paper entitled “A method for registration of 3-D shapes”, IEEE Trans. Pattern Anal, Mach. Intell. 13 (1992) 239-256, has been extensively used as a technique for rigid and affine feature based registration. The ICP is an iterative algorithm that minimizes the sum of the squared distances between all points in a first set and their closest points in a second set (referred to as the target or model point set).

Various instances of the iterative closest point algorithm are discussed in Besl and McKay “A method for registration of 3-D shapes”, IEEE Trans. Pattern Anal. Mach. Intell, 14 (1992) 239-256, Zhang, Z/ “Iterative point matching for registration of free-form curves and surfaces:, International Journal of Computer Vision 13 (1994) 119-152 and, Chen and Medioni “Object modeling by registration of multiple range images”, Image Vision Computing, 10 (1992) 145-155, as well as in a recent literature review Gruen, A, Akca, D, “Least square 3D surface and curve matching” ISPRS Journal of Photogrammery and Remote Sensing” 59 (2205) 151-174. Issues related to groupwise registration problems can be found in Cootes et al., “Groupwise diffeomorphic non-rigid registration for automatic model building”, In: ECCV (4) (2004) 316-327, Zollei et al. “Efficient population registration of 3D data”, In: Computer Vision for Biomedical Image Applications:, International Conference of Computer Vision (2005). More closely related to this invention, Williams and Bennamoun “Simultaneous registration of multiple corresponding point sets”, Computer Vision Understanding 81 (2001) 117-142 proposed a new technique for simultaneously registering multiple corresponding point sets with rigid transformation. This technique does not register images into the same frame but finds the optimal transformation between every two pair in the set of images. Bergevin et al. “Towards a general multi-view registration technique”, IEEE Tyrans, Pattern Anal. Intell, 18 (1996) 540-547 have proposed an iterative algorithm based on an ICP algorithm to register multiple range images. Their algorithm considers the network of views as a whole and minimizes the registration errors of all views simultaneously. Benjemaa and Schmitt, “A solution for registration for multiple 3D point sets using unit quaternions”, In: ECCV '98: Proceedings of the 5th European Conference on Computer Vision-Volume II, London, UK, Springer-Veriag (1998) 34-50 presents an analytic solution for solving the problem of simultaneous registration given correspondences.

### SUMMARY

In accordance with the present invention, a method is provided for registering a collection of m input point sets {P₁, P₂, . . . , Pₘ}, where m is an integer greater than 2. The method includes: identifying a set of m rigid or affine transformations {T₁, T₂, . . . , T ₘ}; and aligning such images comprising determining a mean of the m input point sets {P₁, P₂, . . . , Pₘ} and aligning the images using the determined mean in performing the transformation alignment.

In one embodiment, the method determines the closest points computed from a randomly selected one of the point sets {P₁, P₂, . . . , Pₘ}, and from such determined point set Pᵢ(pk), determines a transformation for each one of the point sets {P₁, P₂, . . . , Pₘ} and updates the point sets {P₁, P₂, . . . , Pₘ}iteratively a fixed number of times or until a change of a predetermined error criterion is below a predetermined threshold.

In another embodiment, the method determines transformations that minimizes the mean squared distances between the elements of point sets {P₁, P₂, . . . , Pₘ} and a point set Pᵢconsidered as a weighted average of the closest points in all other ones of the point sets {P₁, P₂, . . . , Pₘ}; and updates the points set {P₁, P₂, . . . , Pₘ} iteratively a fixed number of times or until a change of the predetermined error criterion is below a predetermined threshold.

The present invention extends image matching using only a pair of point sets (i.e., from registration of only a pair of images) to a collection of point sets (i.e., registration of more than a pair of images). In the context of medical image registration, this collection could represent feature points extracted from a sequence of images of the same patient (over time), or from a population study including images from different patients. In this scenario, most existing strategies rely on a succession of pair-wise ICP. Either one selects an arbitrary reference point set and registers all the others to it or, provided the images come from a time sequence, one registers consecutive images in a pair-wise fashion and obtain the final transformation by composition. These strategies are biased by the selection of a reference or suffer for the propagation of registration errors. The method aligns the images jointly using a dynamically defined reference and therefore is less likely to suffer from these limitations.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow diagram of a method for registering a collection of m input point sets {P₁, P₂, . . . , Pₘ}, where m is an integer, according to one embodiment of the invention; and

FIG. 2 is a flow diagram of a method for registering a collection of m input point sets {P₁, P₂, . . . , Pₘ}, where m is an integer, according to another embodiment of the invention

Like reference symbols in the various drawings indicate like elements.

### DETAILED DESCRIPTION

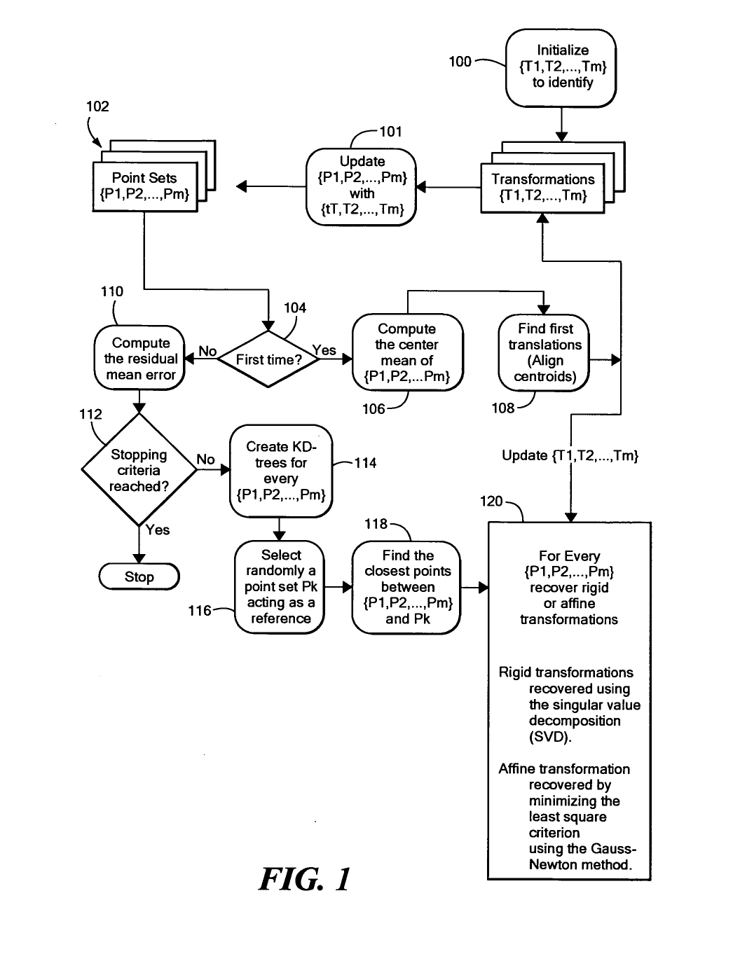

Referring now to FIG. 1 a process is shown for registering a collection of m input point sets (i.e., m images) {P₁, P₂, . . . , Pₘ}, where here m is an integer greater than 2. The process begins by initializing, for each one of the m point sets, a corresponding one of m transformation matrices {T₁, T₂, . . . , Tₘ} (Step 100). The matrices may be rigid or affine transformations. The process receives the collection of m input point sets {P₁, P₂, . . . , Pₘ} (Step 102).

Next, considering that this is the first time the process receives the collection of m input point sets {P₁, P₂, . . . , Pₘ}, (Step 104), the process computes the mean centroid (Step 106), and finds the first transformations (translation). Then, the process aligns the collection of m input point sets {P₁, P₂, . . . , Pₘ} with the determined transformations (translations), Step 101. It is noted that there is only one centroid that corresponds to the mean of all centriods.

Next, the process computes errors between the points sets determined in Step 101-Step 110, using for example, a mean square error process.

Next, the process determines whether the error for each one of the m input point sets {P₁, P₂, . . . , Pₘ} is below a predetermined level (i.e., a predetermined threshold level), Step 112. If the error is above the level, the process creates a KD-tree for each one of the m input point sets {P₁, P₂, . . . , Pₘ}, Step 114 . The process randomly selects one of the m input point sets {P₁, P₂, . . . , Pₘ}, such randomly selected one of the m input point sets {P₁, P₂, . . . , Pₘ} being designates as Pₖ, Step 116. The process then determines the closest points between each one of the m input point sets {P₁, P₂, . . . , Pₘ} and Pₖ, Step 118. From these closest points, the process determines a corresponding (i.e., updated) transformation using, in the case of an rigid transformation single value decomposition or in the case of a affine transformation, minimization using the least square error criterion using the Gauss-Newton method.

Next, each one of the m input point sets {P₁, P₂, . . . , Pₘ} is updated (Step 101) with the updated transformation and the process (i.e., Steps 110, 114, 116, 118, 120, 101) repeats iteratively until the error criteria (Step 112) is met.

The process described in connection with FIG. 1 may be summarized as:
Initialization, for each Pᵢ, where i=1, . . . , m, Tᵢ=I (identity transformation)
for each point set Pᵢ, where i=1, . . . , m (Steps 100 and 102)
   Align the point set centroids. (Steps 106 and 108)
while convergence or max. number iteration not reached (Step 112)
   Randomly select another point set Pⱼ (Pk) in the collection
   for each point set Pᵢ, where i=1, . . . , m
      Compute the KD-trees for every point set Pᵢ
      a Compute the closest points in Pⱼ (Pk)(using its KD-tree)
      Use the correspondences to find the corresponding transformation (Rigid-Affine)
   Update the point set Pⱼ (Pk) with the found transformation, update the global transformations. ≦Compute the residual mean square error (Step 112)

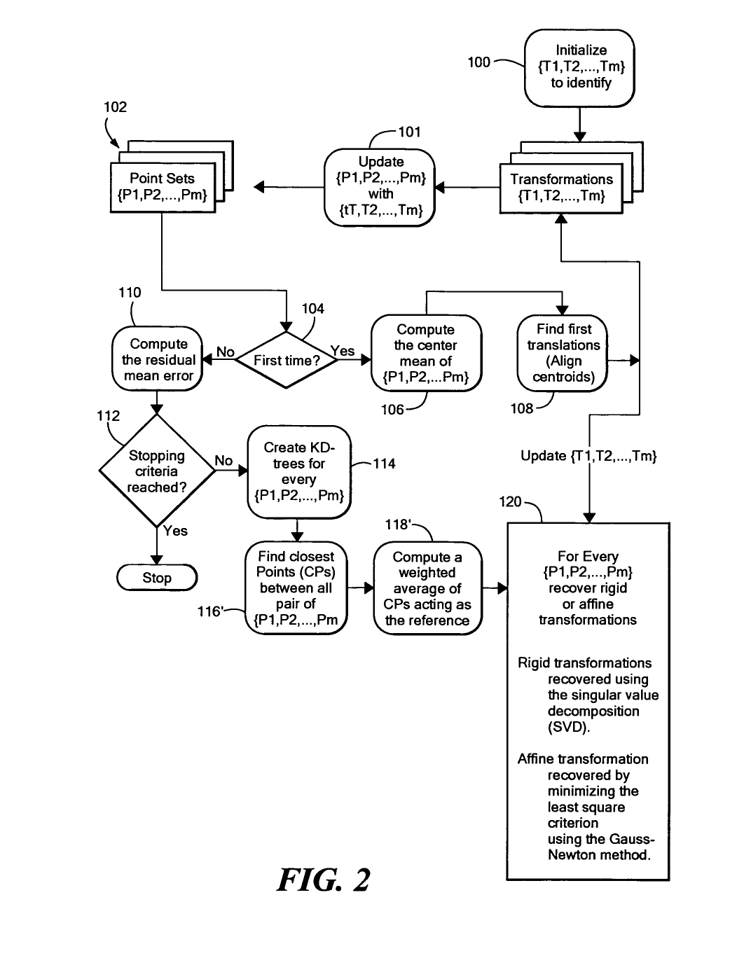

Referring now to FIG. 2, an alternative process is shown for registering a collection of m input point sets (i.e., m images) {P₁, P₂, . . . , Pₘ}. The process again begins by initializing, for each one of the m point sets, a corresponding one of m transformation matrices {T₁, T₂, . . . , Tₘ} as in Step 100. Here, however, after creating the KD-trees in Step 114, the process determines the closest points between all pairs in the m input point sets {P₁, P₂, . . . , Pₘ} Step 116′ and then computes a weighted average of the determined closest points, such average being used to provide a reference, Pₖ,(Step 118′). The process then continues as in Step 120 described abide in connection with FIG. 1.

The process described above in connection with FIG. 2 may be summarized as:
Initialization, for each P_{i where i=}1, . . . , m, Tᵢ=I (identity transformation)
for each point set Pᵢ, where, i=, . . . , m
   Align the point set centroids.
while convergence or max. number iteration not reached
   Compute the KD-trees for every point set Pᵢ (Step 114)
      for each point set Pᵢ, where i=, . . . , m
      Find all closest points to other point sets (using their KD-trees) (Step 116′)
      Compute a weighted average of the closest points (Step 118′)
      Use the correspondence with these averages to find the corresponding transformation (Rigid-Affine) (120)
   Update the point sets with the found transformations, update the global transformations.
   Compute the residual mean square error
      Note that the problem of computing the geometric transformation from correspondences is solved as follows:
Rigid transformation. The optimal rigid transformation is computed using the singular value decomposition (SVD) of the cross-covariance matrix described below (Eq. 2) based on Arun et al.'s algorithm (Arun, K. S., Huang, T. S., Blostein, S. D., “Least-squares fitting of two 3-d point sets”, IEEE Trans. Pattern Anal, Mach. Intell. 9 (1987) 698-700) (Besl's and McKay algorithm (“A method for registration of 3-D shapes”, IEEE Trans. Pattern Anal, Mach. Intell. 13 (1992) 239-256) optimal solution is found using quaternions). The centriods and the cross-covariance matrix Σ² of the sets Pₓ and P_{y} are:

$$\begin{matrix}{μ}_{x} = \frac{1}{n} {\sum }_{i = 1}^{n} {x}_{i} and {μ}_{y} = \frac{1}{n} {\sum }_{i = 1}^{n} {y}_{i} & ( 1 ) \\ {Σ}^{2} = \frac{1}{n} {\sum }_{i = 1}^{n} [ ( {y}_{i} - {μ}_{y} ) {( {x}_{i} - {μ}_{x} )}^{′} ] = \frac{1}{n} {\sum }_{i = 1}^{n} {y}_{i} {x}_{i} - {μ}_{y} {μ}_{x} & ( 2 )\end{matrix}$$
Affine transformation. The process obtains the parameters of the affine transformation (in matrix form) by minimization of a least square criterion using the Gauss-Newton iterative minimization method.

A number of embodiments of the invention have been described. Nevertheless, it will be understood that various modifications may be made without departing from the spirit and scope of the invention. Accordingly, other embodiments are within the scope of the following claims.

What is claimed is:

1. A method for registering a collection of m input point sets {P₁, P₂, . . . , Pₘ}, where m is an integer greater than 2, comprising:
identifying a set of m rigid or affine transformations {T₁, T₂, . . . , Tₘ};
aligning such images comprising determining a mean of the m input point sets {P₁, P₂, . . . , Pₘ} and aligning the images using the determined mean in performing the transformation alignment.

2. The method recited in claim 1 wherein the method determines the closest points computed from a randomly selected one of the point sets {P₁, P₂, . . . , Pₘ}, and from such determined point set, determines a transformation for each one of the point sets {P₁, P₂, . . . , Pₘ} and updates the points sets {P₁, P₂, . . . , Pₘ} iteratively a fixed number of times or until a change of a predetermined error criterion, such as for example the mean squared error or the maximum absolute error, is below a predetermined threshold.

3. The method recited in claim 1 wherein the method determines the transformation that minimizes the mean squared distance between the elements of point sets {P₁, P₂, . . . , Pₘ} and a weighted average of the closest points in all other ones of the point sets {P₁, P₂, . . . , Pₘ}; and updates the set points {P₁, P₂, . . . , Pₘ} iteratively a fixed number of times or until a change of the a predetermined error criterion, such as for example the mean squared error or the maximum absolute error, is below a predetermined threshold.

4. A method for registering a collection of m input point sets {P₁, P₂, . . . , Pₘ}, where m is an integer, comprising:
identifying a set of m rigid or affine transformations {T₁, T₂, . . . , Tₘ};
aligning such images comprising determining a mean of the m input point sets {P₁, P₂, . . . , Pₘ} and aligning the images using the determined mean in performing the transformation alignment; and
wherein the method includes determining the closest points computed from a randomly selected one of the point sets {P₁, P₂, . . . , Pₘ}, and from such determined points, determining a transformation for each one of the point sets {P₁, P₂, . . . , Pₘ} and updating the set points {P₁, P₂, . . . , Pₘ} iteratively a fixed number of times or until a change of a predetermined error criterion is below a predetermined threshold.

5. A method for registering a collection of m input point sets {P₁, P₂, . . . , Pₘ}, where m is an integer, comprising:
identifying a set of m rigid or affine transformations {T₁, T₂, . . . , Tₘ};
aligning such images comprising determining a mean of the m input point sets {P₁, P₂, . . . , Pₘ} and aligning the images using the determined mean in performing the transformation alignment; and
wherein the method includes determining the transformation that minimizes the mean squared distance between the point set {P₁, P₂, . . . , Pₘ} and a weighted average of the closest points in all other ones of the point sets {P₁, P₂, . . . , Pₘ}; and updates the set points {P₁, P₂, . . . , Pₘ} iteratively a fixed number of times or until a change of a predetermined error criterion is below a predetermined threshold.

6. The method recited in claim 5 wherein the predetermined error criterion is mean square error.

7. The method recited in claim 5 wherein the predetermined error criterion is maximum absolute error.
